(19) United States
(12) Patent Application Publication
(10) Pub. No.: US 2008/0285748 A1
(43) Pub. Date: Nov. 20, 2008

(54) Method for generating secret key in computer device and obtaining the encrypting and decrypting key

(75) Inventors: Shih-Chun Lee, Taipei City (TW); Jen-Chung Yang, Taipei City (TW); Yao-Ming Yang, Taipei City (TW); Ding-Long Liu, Taipei City (TW); Hsu-Hsiu Cheng, Taipei City (TW)

Correspondence Address: BACON & THOMAS, PLLC, 625 SLATERS LANE, FOURTH FLOOR, ALEXANDRIA, VA, 22314-1176, US

(73) Assignee: ASUSTEK COMPUTER INC., Taipei City (TW)

(21) Appl. No.: 12/149,190

(22) Filed: Apr. 29, 2008

(30) Foreign Application Priority Data
May 18, 2007 (TW) 096117731

(51) Int. Cl. H04L 9/00

(52) U.S. Cl. 380/44; 380/277

(57) ABSTRACT

The invention relates to a method for generating an secret key in a computer device and using the secret key. The method includes the step of receiving an inputted password first, then processing the inputted password with a device key to generate a user certificate, wherein the device key is established according to the information which is dependent on the computer device and is stored in the non-volatile storage device.

### BACKGROUND OF THE INVENTION

1. Field of the Invention

The invention relates to a technical filed of encrypting files and, more particularly, to a method for generating a secret key in a computer device and obtaining the secret key.

2. Description of the Related Art

Nowadays, the computer is used widely, so that information transmission becomes more and more easy. However, how to provide enough safety for the data files in a computer device is a problem, and therefore, a common computer device provides a function of protecting data files by a password to protect the data.

In the function of protecting the safety of data files by a password in a computer device, the protecting mechanism of setting a password by a user is most popular. FIG. 1 is a schematic diagram showing how to protect the data file 11 by a password inputted by a user in a conventional computer device. An encrypting arithmetic is used to execute an encrypting calculation D for the original data file 11 by a data encrypting and decrypting key obtained by using the password and the user account as the index, and then an encrypted data file 12 is generated. If a user wants to store the encrypted data file 12, he needs to input correct password to decrypt the encrypted data file 12 into the original data file 12.

The mechanism of protecting data files by a password is obtaining the needed information for encrypting and decrypting by inputting a correct password. Since the passwords or the needed private information for encrypting or decrypting needs to be stored in the hard disk drive of a computer at last, and the passwords are easy to be captured and deciphered, and program segment for verifying the password is also easy to be deciphered by a method of visiting the memory.

### BRIEF SUMMARY OF THE INVENTION

One objective of the invention is to provide a method for generating a secret key in a computer device and using the secret key to reinforce the information protection.

According to one characteristic of the invention, a method of generating a secret key in a computer device is provided. The computer device has a non-volatile storage device storing the information dependent on the computer device. The method includes the step of (A) receiving an inputted password, and (B) processing the inputted password with a device key to generate a user certificate having the secret key, wherein the device key is established according to the information which is dependent on the computer device and stored in the non-volatile storage device.

According to another characteristic of the invention, a method for obtaining the secret key in a computer device is provided. The computer device has a non-volatile storage device storing information dependent on the computer device. The computer device provides a user certificate generated by a first password and a device key, wherein the device key is established according to the information which is dependent on the computer device and stored in non-volatile storage device. The method includes the steps of (A) obtaining the user certificate, (B) receiving a second input password, (C) computing the first password according to the device key and the user certificate, and (D) examining whether the second password corresponds to the first password for establishing the user certificate and obtaining a security key from the user certificate to execute encryption or decryption if the second password corresponds to the first password.

In the invention, the combination of the software and hardware in the computer device is utilized, and the password inputted by a user and the private information needed in encrypting and decrypting are stored in a non-volatile storage device via system firmware. Since the non-volatile storage device is unlike the hard disk drive and is not easy to be accessed by spiteful intrusion or Trojan programs, and therefore, the objective of reinforcing the information protection can be achieved. Since the private information needed in encrypting and decrypting is related to specific hardware, if the encrypted file is intercepted, coped, it cannot be decrypted because of the absence of the private information in specific hardware. In addition, the system firmware is also responsible for verifying the sensitive program segment such as passwords, and the chance of breaking via visiting the memory is greatly reduced. The non-volatile storage device and the system firmware needed in the invention are necessary device in the present computer device, and therefore the invention only needs to be supported by software without extra chip or other hardware device.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing the conventional method of protecting data files by inputting a password by a user in a computer device;

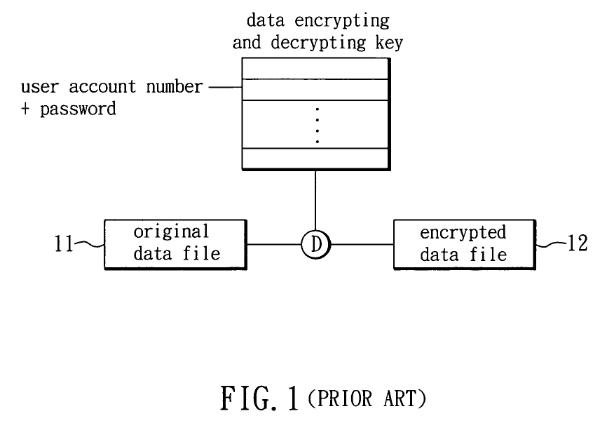

FIG. 2 is a schematic diagram showing the computer device executing the method of generating a secret key and using the encrypting and decrypting according to the embodiment of the invention;

FIG. 3 is a flowchart showing the method of generating an secret key in a computer device according to the embodiment of the invention; and

FIG. 4 is a flowchart showing the method of using the secret key in the computer device according to the embodiment of the invention.

### DETAILED DESCRIPTION OF THE EMBODIMENTS

The following embodiments are used to explain the implementing manner of the invention, people having ordinary skills in the art can easily know about the advantages and effect of the inventions from the content disclosed in the specification.

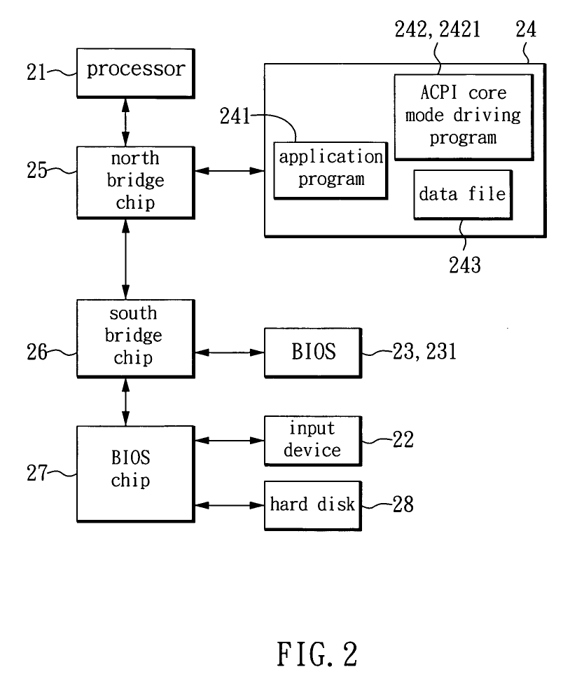

As for the method of generating a secret key and obtaining the secret key in a computer device according to an embodiment of the invention, please refer to FIG. 2, which is a schematic diagram showing the computer device according to the embodiment of the invention. As show in FIG. 2, the computer device has a processor 21 such as a CPU, an input device 22, a non-volatile storage device 23, a memory 24, a north bridge chip 25, a south bridge chip 26, a super input-output chip 27 and a hard disk drive 28. The processor 21 is an operation control center of the computer device and is used for executing system programs and application programs to provide functions of processing various data. The north bridge chip 25 is coupled to the processor 21, the memory 24 and the south bridge chip 26 to operate the contact with the processor 21, control the read and write of the memory 24, control the bus and control the data transmission with the south bridge chip 26. The south bridge chip 26 is coupled to the non-volatile storage device 23 and the super input-output chip 27, respectively, and is coupled to the processor 21 via the north bridge chip 25. The south bridge chip 44 is responsible for communicating with the super input-output chip 27 and the peripheral device and so on. The super input-output chip 27 is coupled to the input device 22 and the hard disk drive 28 to provide the function of outputting and inputting.

The input device 22 is, for example, a keyboard for inputting data to a computer device by a user. The memory 24 can store the application program 241, driving program 242 or other software program executed by the processor 21, the data files 243 or other types of files processed by the processor 21. The non-volatile storage device 23 is, for example a basic input-output system (BIOS) 231, and the system firmware of the non-volatile storage device is used to initialize the hardware, examine the hardware function and guide the operating system in boosting up. The BIOS 231 stores the information dependent on the computer device, which is, for example, MAC address and processor serial number and so on, and stores the time stamp related to the computer device.

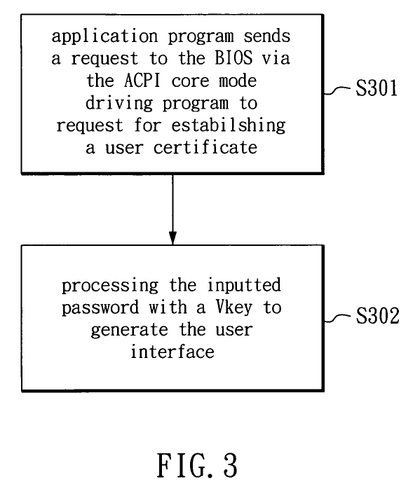

Please refer to FIG. 3, which is a flowchart showing the method for generating a secret key in a computer device according to the embodiment of the invention. First, an application program 241 sends a request to the system firmware of the BIOS 231 via an advanced configuration and power interface (ACPI) kernel-mode driver 2421 to establish a user certificate (step S301), wherein the request includes the password inputted by a user.

After the system firmware of the BIOS 231 receives the request, the password inputted by the user is processed with a device key to generate the user certificate (step S302), wherein the processing of generating the user certificate having the secret key is the reversible processing of a shift function, and the device key is established according to the information which is dependent on the computer device and stored in the non-volatile storage device 23. For example, the information such as the MAC address and processor serial number stored in the BIOS 231 is operated by functions to generate the device key, or the time stamp or other information dependent on the computer device is operated by functions to generate the device key. Since the MAC address and the processor serial number are unique, the generated device key is also unique. The generated user certificate is stored in the hard disk drive 28.

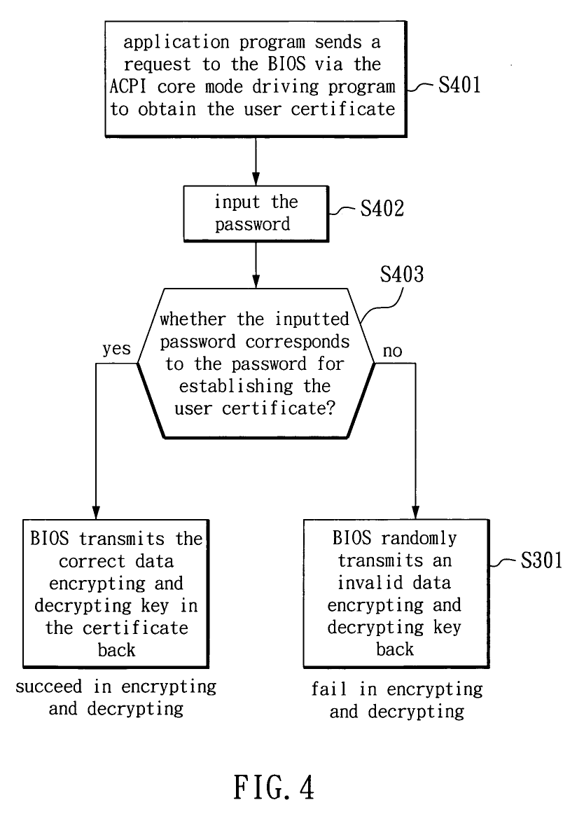

Please refer to FIG. 4 which is a method of obtaining the secret key in a computer device according to the embodiment of the invention. The method is used to encrypt or decrypt for a data file 243. First, the application program 241 sends a request to the system firmware of the BIOS 231 via the ACPI kernel-mode driver 2421 to get the user certificate having the secret key obtained via the method of generating the encrypting or decrypting key (step S401), and the user is demanded to input a password’ (step S402). Then, the system firmware of the BIOS 231 computes the password in the user certificate by the device key and the user certificate and examines whether the inputted password’ corresponds to the password in the user certificate (step S403), and if it is yes, the secret key in the user certificate is restored via the device key and the inputted password’(step S403), and the secret key is used to finish encrypting and decrypting successfully.

In the embodiment of the invention, the combination of the software and hardware in the computer device is utilized, and the password inputted by a user and the private information needed in encrypting and decrypting are stored in a non-volatile storage device. Since the non-volatile storage device is unlike the hard disk drive and is not easy to be accessed by spiteful intrusion or Trojan programs, and therefore, the objective of reinforcing the information protection can be achieved. Since the private information needed in encrypting and decrypting is related to specific hardware, if the encrypted file is intercepted, coped, it cannot be deciphered because of the absence of the private information in specific hardware. In addition, the system firmware is also responsible for verifying the sensitive program segment such as passwords, and the chance of decrypting the password via visiting the memory is greatly reduced. The non-volatile storage device and the system firmware needed in the invention are necessary devices in the present computer device, and therefore the invention only needs to be supported by software without extra chip or other hardware device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for generating a secret key in a computer device having a non-volatile storage device which stores information dependent on the computer device, the method comprising the steps of:
(A) receiving an inputted password; and
(B) processing the inputted password with a device key to generate a user certificate having the secret key, wherein the device key is established according to the information which is dependent on the computer device and stored in the non-volatile storage device.

2. The method according to claim 1, wherein the non-volatile storage device is a basic input-output system (BIOS) unit.

3. The method according to claim 2, wherein in the step (B), the information which is dependent on the computer device comprises a MAC address and a processor serial number stored in the BIOS unit.

4. The method according to claim 2, wherein in the step (B), when the password is inputted, an application program of the computer sends a request to the BIOS unit via an advanced configuration and power interface (ACPI) kernel-mode driver to establish the user certificate.

5. The method according to claim 4, wherein in the step (B), the user certificate is stored in a hard disk drive of the computer device.

6. The method according to claim 1, wherein in the step (B), the processing of generating the user certificate is a reversible processing of a shift function.

7. A method for using a secret key in a computer device, wherein the computer device has a non-volatile storage device storing information dependent on the computer device and provides a user certificate generated by a first password and a device key having the secret key which is established according to the information which is dependent on the computer device and stored in the non-volatile storage device, the method comprising the steps of:
(A) obtaining the user certificate;
(B) receiving a second input password;
(C) computing the first password according to the device key and the user certificate; and
(D) examining whether the second password corresponds to the first password, and obtaining the security key from the user certificate if the second password corresponds to the first password.

8. The method according to claim 7, wherein the non-volatile storage device is a BIOS unit.

9. The method according to claim 8, wherein the information comprises a MAC address and a processor serial number stored in the BIOS unit.

10. The method according to claim 9, wherein in the step (A), an application program of the computer sends a request to the BIOS unit via an ACPI kernel-mode driver to obtain the user certificate.
